(19) United States
(12) Patent Application Publication
(10) Pub. No.: US 2026/0303447 A1
(43) Pub. Date: Oct. 1, 2026

(54) METHODS AND APPARATUS FOR IDENTIFIER CONFIGURATION

(71) Applicant: Nokia Technologies Oy, Espoo (FI)

(72) Inventors: Orhan Okan MUTGAN, Shanghai (CN); Zhi Jie YANG, Shanghai (CN); Gang CHENG, Shanghai (CN); Yi Ming JIANG, Shanghai (CN); Jian Guo LIU, Shanghai (CN); Ye LUO, Shanghai (CN)

(73) Assignee: Nokia Technologies Oy, Espoo (FI)

(21) Appl. No.: 19/488,974

(22) PCT Filed: Jun. 2, 2023
(86) PCT No.: PCT/CN2023/098131

§ 371 Date: Dec. 1, 2025

(51) Int. Cl. H04L 41/0803; H04L 9/40; H04L 41/0677; H04L 41/34; H04L 61/5038; H04L 61/5092; H04L 101/622; H04W 8/26; H04W 12/02

(52) U.S. Cl. CPC H04L 41/0803; H04L 41/0677; H04L 41/34; H04L 61/5038; H04L 61/5092; H04L 63/0876; H04W 8/26; H04W 12/02; H04L 2101/622

(57) ABSTRACT

Methods, apparatus and computer-readable medium are disclosed for identifier configuration. In an embodiment, there is provided a method performed at an access point. The method comprises receiving, from a first wireless device, a first identifier of the first wireless device. The first identifier is determined by the first wireless device. The method further comprises determining whether the first identifier is same as one of one or more second identifiers of one or more second wireless devices associated with the access point. The method further comprises according to the determination, transmitting, to the first wireless device, identifier indication information indicating whether an identifier collision occurs.

### TECHNICAL FIELD

Embodiments of the disclosure generally relate to wireless communication technology, and more particularly, to methods and apparatus for identifier configuration.

### BACKGROUND

In conventional 802.11 standards, a non-access point (non-AP) station (STA), which may be simply referred to as an STA in the present disclosure, and an access point (AP) use a fixed unencrypted medium access control (MAC) address in a frame header. This causes a security concern by allowing others to track the STA and the AP based on their MAC addresses. To prevent an STA and an AP from being tracked and improve the privacy of 802.11 standards, a MAC address randomization or random and changing MAC (RCM) became a common technique. Within this regard, institute of electrical and electronics engineers (IEEE) 802.11bh and 802.11bi groups focus on identification of an STA using a random MAC address (RMA) without decreasing user privacy.

The 802.11bh group focuses on STA identification through MAC randomization in a pre-association phase, that is, an STA does not change its MAC address after association (i.e., post-association). Rather, it changes its MAC address before the association, and keeps using the same MAC address while associated. On the other hand, the 802.11bi group addresses privacy concerns as a part of its work and manages to solve the case where an STA can also change its MAC address after association.

To identify an STA with RMA, there are several proposals [22/187r2, 22/925r3, 22/895r1, 22/888r2, 22/158r3, 22/1801r1, 23/129r3, 23/441r0] in 802.11bh and [22/114r3] in 802.11bi. Basically, in the proposed mechanisms, an STA is configured an identifier via at least one of the following: 1) an AP configures identifier to an STA, and thus, this identifier may be called a “network generated identifier”; 2) an STA configures identifier to itself, and thus, this identifier may be called an “STA generated identifier”; or 3) both AP and STA generate identifiers locally through a common procedure (e.g., using an identifier generation function), and thus, this identifier may be called an “commonly generated identifier”.

An STA uses a configured identifier depending on the mechanism. For example, as shown in FIG. 1A which gives an example of a network generated identifier, an AP configures (or assigns) an identify (ID) to an STA in an association (e.g., first association), and the STA uses the configured ID in a subsequent association (e.g., second association). In the example of FIG. 1A, the identifier is the ID. More details about this example can be obtained from e.g. 22/187r2. As shown in FIG. 1B which gives an example of an STA generated identifier, an STA configures (or assigns) an RMA to itself in an association (e.g., first association), and the STA uses the configured RMA in a subsequent association (e.g., second association). In the example of FIG. 1B, the identifier is the RMA. More details about this example can be obtained from e.g. 23/129r3. As shown in FIG. 1C which gives an example of a commonly generated identifier, an STA and an AP generate (or configure) a same RMA (used by the STA) while the STA is associated with the AP (e.g., during a first association). In the example of FIG. 1C, the identifier is the RMA. More details about this example can be obtained from e.g. 22/114r3.

### SUMMARY

This summary is provided to introduce simplified concepts of the present disclosure. This summary is not intended to identify key features or essential features of the claimed subject matter, nor is it intended to be used to limit the scope of the claimed subject matter.

According to a first aspect of the disclosure, there is provided an apparatus at an access point. The apparatus comprises at least one processor, and at least one memory storing instructions that, when executed on the at least one processor, cause the apparatus at least to receive, from a first wireless device, a first identifier of the first wireless device. The first identifier is determined by the first wireless device. When the instructions are executed on the at least one processor, the instructions further cause the apparatus at least to determine whether the first identifier is same as one of one or more second identifiers of one or more second wireless devices associated with the access point. When the instructions are executed on the at least one processor, the instructions further cause the apparatus at least to, according to the determination, transmit, to the first wireless device, identifier indication information indicating whether an identifier collision occurs.

According to some embodiments, when the instructions are executed by the at least one processor, the instructions may cause the apparatus at least to transmit the identifier indication information by: in case that the first identifier is same as one of the one or more second identifiers, transmitting, to the first wireless device, the identifier indication information indicating at least one of: an occurrence of an identifier collision, or an operation for addressing the identifier collision.

According to some embodiments, the identifier indication information indicating at least one of an occurrence of an identifier collision, or an operation for addressing the identifier collision may comprise one or more of: a first indicator indicating an occurrence of an identifier collision; a second indicator instructing the first wireless device to use a new first identifier of the first wireless device; or a third indicator instructing the first wireless device to reuse a previous first identifier of the first wireless device. The previous first identifier has been previously used by the first wireless device without resulting in an identifier collision.

According to some embodiments, when the instructions are executed by the at least one processor, the instructions may further cause the apparatus at least to perform one of: receiving, from the first wireless device, a new first identifier of the first wireless device, wherein the new first identifier is determined by the first wireless device; receiving, from the first wireless device, a previous first identifier of the first wireless device, wherein the previous first identifier has been previously used by the first wireless device without resulting in an identifier collision; and determining a new first identifier of the first wireless device and transmitting the new first identifier to the first wireless device.

According to some embodiments, the new first identifier may be determined and transmitted in response to a request from the first wireless device.

According to some embodiments, when the instructions are executed by the at least one processor, the instructions may cause the apparatus at least to transmit the identifier indication information by: in case that the first identifier is different from any one of the one or more second identifiers, transmitting, to the first wireless device, the identifier indication information indicating a positive feedback for the first identifier.

According to some embodiments, the identifier indication information indicating a positive feedback for the first identifier may comprise one or more of: a fourth indicator indicating that the first identifier is acknowledged by the access point; or a fifth indicator indicating that the use of the first identifier by the first wireless device is successful.

According to some embodiments, the identifier indication information may be transmitted as one of: a reason code; a status code; or an information element.

According to some embodiments, the information element may comprise: a first field indicating an element identifier of the information element; a second field indicating a length of the information element; a third field indicating an element identifier extension of the information element; and an indication content of the information element.

According to some embodiments, the identifier indication information may be transmitted as one of: a reason code in a de-authentication frame, a disassociation frame, and/or an action frame; a status code in an authentication frame, an association response frame, and/or an action frame; or an information element in an authentication frame, an association response frame, and/or an already existing action frame or a newly defined action frame.

According to some embodiments, the newly defined action frame may comprise one or more of: a fourth field indicating a category code of the newly defined action frame; a fifth field indicating whether the newly defined action frame is a request or a response; the identifier indication information; or the first identifier of the first wireless device.

According to some embodiments, the first identifier of the first wireless device may be one of: an identity of the first wireless device; a random medium access control (MAC) address of the first wireless device that is independently determined by the first wireless device; or a random MAC address of the first wireless device that is determined by the first wireless device and the access point through a common procedure.

According to a second aspect of the disclosure, there is provided an apparatus at a first wireless device. The apparatus comprises at least one processor, and at least one memory storing instructions that, when executed on the at least one processor, cause the apparatus at least to determine a first identifier of the first wireless device. When the instructions are executed on the at least one processor, the instructions further cause the apparatus at least to transmit the first identifier to an access point. When the instructions are executed on the at least one processor, the instructions further cause the apparatus at least to receive, from the access point, identifier indication information indicating whether an identifier collision occurs.

According to some embodiments, when the instructions are executed by the at least one processor, the instructions may cause the apparatus at least to receive the identifier indication information by: receiving the identifier indication information indicating at least one of: an occurrence of an identifier collision, or an operation for addressing the identifier collision.

According to some embodiments, the identifier indication information indicating at least one of an occurrence of an identifier collision, or an operation for addressing the identifier collision may comprise one or more of: a first indicator indicating an occurrence of an identifier collision; a second indicator instructing the first wireless device to use a new first identifier of the first wireless device; or a third indicator instructing the first wireless device to reuse a previous first identifier of the first wireless device. The previous first identifier has been previously used by the first wireless device without resulting in an identifier collision.

According to some embodiments, when the instructions are executed by the at least one processor, the instructions may further cause the apparatus at least to perform one of: determining a new first identifier of the first wireless device and transmitting the new first identifier to the access point; transmitting, to the access point, a previous first identifier of the first wireless device, wherein the previous first identifier has been previously used by the first wireless device without resulting in an identifier collision; and receiving, from the access point, a new first identifier of the first wireless device, wherein the new first identifier is determined by the access point.

According to some embodiments, the new first identifier may be received in response to a request from the first wireless device to the access point.

According to some embodiments, when the instructions are executed by the at least one processor, the instructions may cause the apparatus at least to receive the identifier indication information by: receiving the identifier indication information indicating a positive feedback for the first identifier.

According to some embodiments, the identifier indication information indicating a positive feedback for the first identifier may comprise one or more of: a fourth indicator indicating that the first identifier is acknowledged by the access point; or a fifth indicator indicating that the use of the first identifier by the first wireless device is successful.

According to some embodiments, the identifier indication information may be received as one of: a reason code; a status code; and an information element.

According to some embodiments, the information element may comprise: a first field indicating an element identifier of the information element; a second field indicating a length of the information element; a third field indicating an element identifier extension of the information element; and an indication content of the information element.

According to some embodiments, the identifier indication information may be received as one of: a reason code in a de-authentication frame, a disassociation frame, and/or an action frame; a status code in an authentication frame, an association response frame, and/or an action frame; or an information element in an authentication frame, an association response frame, and/or an already existing action frame or a newly defined action frame.

According to some embodiments, the newly defined action frame may comprise one or more of: a fourth field indicating a category code of the newly defined action frame; a fifth field indicating whether the newly defined action frame is a request or a response; the identifier indication information; or the first identifier of the first wireless device.

According to some embodiments, the first identifier of the first wireless device may be one of: an identity of the first wireless device; a random MAC address of the first wireless device that is independently determined by the first wireless device; or a random MAC address of the first wireless device that is determined by the first wireless device and the access point through a common procedure.

According to a third aspect of the disclosure, there is provided a method performed at an access point. The method comprises receiving, from a first wireless device, a first identifier of the first wireless device. The first identifier is determined by the first wireless device. The method further comprises determining whether the first identifier is same as one of one or more second identifiers of one or more second wireless devices associated with the access point. The method further comprises, according to the determination, transmitting, to the first wireless device, identifier indication information indicating whether an identifier collision occurs.

According to some embodiments, transmitting the identifier indication information may comprise: in case that the first identifier is same as one of the one or more second identifiers, transmitting, to the first wireless device, the identifier indication information indicating at least one of: an occurrence of an identifier collision, or an operation for addressing the identifier collision.

According to some embodiments, the identifier indication information indicating at least one of an occurrence of an identifier collision, or an operation for addressing the identifier collision may comprise one or more of: a first indicator indicating an occurrence of an identifier collision; a second indicator instructing the first wireless device to use a new first identifier of the first wireless device; or a third indicator instructing the first wireless device to reuse a previous first identifier of the first wireless device. The previous first identifier has been previously used by the first wireless device without resulting in an identifier collision.

According to some embodiments, the method may further comprise one of: receiving, from the first wireless device, a new first identifier of the first wireless device, wherein the new first identifier is determined by the first wireless device; receiving, from the first wireless device, a previous first identifier of the first wireless device, wherein the previous first identifier has been previously used by the first wireless device without resulting in an identifier collision; and determining a new first identifier of the first wireless device and transmitting the new first identifier to the first wireless device.

According to some embodiments, the new first identifier may be determined and transmitted in response to a request from the first wireless device.

According to some embodiments, transmitting the identifier indication information may comprise: in case that the first identifier is different from any one of the one or more second identifiers, transmitting, to the first wireless device, the identifier indication information indicating a positive feedback for the first identifier.

According to some embodiments, the identifier indication information indicating a positive feedback for the first identifier may comprise one or more of: a fourth indicator indicating that the first identifier is acknowledged by the access point; or a fifth indicator indicating that the use of the first identifier by the first wireless device is successful.

According to some embodiments, the identifier indication information may be transmitted as one of: a reason code; a status code; or an information element.

According to some embodiments, the information element may comprise: a first field indicating an element identifier of the information element; a second field indicating a length of the information element; a third field indicating an element identifier extension of the information element; and an indication content of the information element.

According to some embodiments, the identifier indication information may be transmitted in one of following frames: an authentication/de-authentication frame; a disassociation frame; or a newly defined action frame.

According to some embodiments, the newly defined action frame may comprise one or more of: a fourth field indicating a category code of the newly defined action frame; a fifth field indicating whether the newly defined action frame is a request or a response; the identifier indication information; or the first identifier of the first wireless device.

According to some embodiments, the first identifier of the first wireless device may be one of: an identity of the first wireless device; a random MAC address of the first wireless device that is independently determined by the first wireless device; or a random MAC address of the first wireless device that is determined by the first wireless device and the access point through a common procedure.

According to fourth aspect of the disclosure, there is provided a method performed at a first wireless device. The method comprises determining a first identifier of the first wireless device. The method further comprises transmitting the first identifier to an access point. The method further comprises receiving, from the access point, identifier indication information indicating whether an identifier collision occurs.

According to some embodiments, receiving the identifier indication information may comprise: receiving the identifier indication information indicating at least one of: an occurrence of an identifier collision, or an operation for addressing the identifier collision.

According to some embodiments, the identifier indication information indicating at least one of an occurrence of an identifier collision, or an operation for addressing the identifier collision may comprise one or more of: a first indicator indicating an occurrence of an identifier collision; a second indicator instructing the first wireless device to use a new first identifier of the first wireless device; or a third indicator instructing the first wireless device to reuse a previous first identifier of the first wireless device. The previous first identifier has been previously used by the first wireless device without resulting in an identifier collision.

According to some embodiments, the method may further comprise one of: determining a new first identifier of the first wireless device and transmitting the new first identifier to the access point; transmitting, to the access point, a previous first identifier of the first wireless device, wherein the previous first identifier has been previously used by the first wireless device without resulting in an identifier collision; and receiving, from the access point, a new first identifier of the first wireless device, wherein the new first identifier is determined by the access point.

According to some embodiments, the new first identifier may be received in response to a request from the first wireless device to the access point.

According to some embodiments, receiving the identifier indication information may comprise: receiving the identifier indication information indicating a positive feedback for the first identifier.

According to some embodiments, the identifier indication information indicating a positive feedback for the first identifier may comprise one or more of: a fourth indicator indicating that the first identifier is acknowledged by the access point; or a fifth indicator indicating that the use of the first identifier by the first wireless device is successful.

According to some embodiments, the identifier indication information may be received as one of: a reason code; a status code; and an information element.

According to some embodiments, the information element may comprise: a first field indicating an element identifier of the information element; a second field indicating a length of the information element; a third field indicating an element identifier extension of the information element; and an indication content of the information element.

According to some embodiments, the identifier indication information may be received in one of following frames: an authentication/de-authentication frame; a disassociation frame; and a newly defined action frame.

According to some embodiments, the newly defined action frame may comprise one or more of: a fourth field indicating a category code of the newly defined action frame; a fifth field indicating whether the newly defined action frame is a request or a response; the identifier indication information; or the first identifier of the first wireless device.

According to some embodiments, the first identifier of the first wireless device may be one of: an identity of the first wireless device; a random MAC address of the first wireless device that is independently determined by the first wireless device; or a random MAC address of the first wireless device that is determined by the first wireless device and the access point through a common procedure.

According to fifth aspect of the disclosure, there is provided a computer readable storage medium, on which instructions are stored. When executed by at least one processor, the instructions cause the at least one processor to perform any method according to the third or fourth aspect.

According to sixth aspect of the disclosure, there is provided computer program product comprising instructions which when executed by at least one processor, cause the at least one processor to perform any method according to the third or fourth aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings in which:

FIGS. 1A-1C illustrate different examples of identifier configuration;

FIG. 2A illustrates a case where no identifier collision occurs;

FIG. 2B illustrates a case where identifier collision might occur;

FIG. 3 is a flow chart depicting a method performed at an access point according to an embodiment of the present disclosure;

FIGS. 4A-4B are flow charts for explaining the method of FIG. 3;

FIGS. 5A-5C are flow charts each depicting a method performed at an access point according to an embodiment of the present disclosure;

FIG. 6 is a flow chart depicting a method performed at a first wireless device according to an embodiment of the present disclosure;

FIGS. 7A-7B are flow charts for explaining the method of FIG. 6;

FIGS. 8A-8C are flow charts each depicting a method performed at a first wireless device according to an embodiment of the present disclosure;

FIG. 9 is a flow chart depicting an exemplary process according to an embodiment of the present disclosure;

FIG. 10 illustrates an exemplary example of identifier indication information as reason code;

FIG. 11 illustrates an exemplary example of identifier indication information as status code;

FIGS. 12A-12B illustrate an exemplary example of identifier indication information as information element;

FIGS. 13A-13C illustrate an exemplary example of a newly defined action frame carrying identifier indication information;

FIG. 14 is a flow chart depicting an exemplary process according to an embodiment of the present disclosure;

FIG. 15 is a flow chart depicting an exemplary process according to an embodiment of the present disclosure;

FIG. 16 is a flow chart depicting an exemplary process according to an embodiment of the present disclosure;

FIG. 17 shows a simplified block diagram of an apparatus according to an embodiment of the present disclosure.

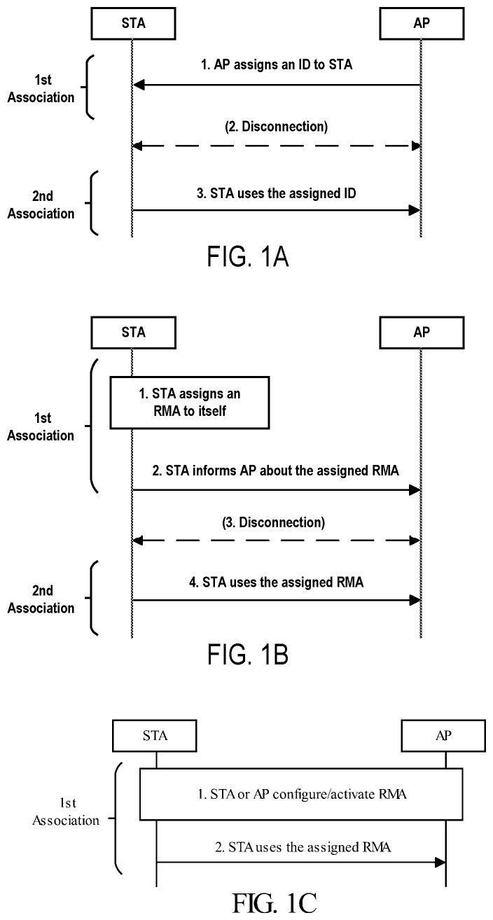

### DETAILED DESCRIPTION

Some example embodiments will now be described in more detail hereinafter with reference to the accompanying drawings, in which some, but not all embodiments are shown. Indeed, the example embodiments may take many different forms and should not be construed as fixed to the embodiments set forth herein; rather, these embodiments are provided so that this disclosure will satisfy applicable legal requirements. Like reference numerals refer to like elements throughout.

References in the present disclosure to “one embodiment”, “an embodiment”, “an example embodiment”, and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

In the following description and claims, unless defined otherwise, all technical and scientific terms used herein have the same meaning as commonly understood by one of ordinary skills in the art to which this disclosure belongs.

As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of “circuitry” applies to all uses of this term in this application, including in any claims. As a further example, as used in this application, the term “circuitry” also covers an implementation of merely a hardware circuit or processor (or multiple processors) or portion of a hardware circuit or processor and its (or their) accompanying software and/or firmware. The term “circuitry” also covers, for example and if applicable to the particular claim element, a baseband integrated circuit or processor integrated circuit for a mobile device or a similar integrated circuit in server, a cellular network device, or other computing or network device.

As defined herein, a “computer-readable storage medium,” which refers to a non-transitory physical storage medium (e.g., volatile or non-volatile memory device), can be differentiated from a “computer-readable transmission medium,” which refers to an electromagnetic signal. Such a medium may take many forms, including, but not limited to a non-transitory computer-readable storage medium (e.g., non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Examples of non-transitory computer-readable media include a magnetic computer readable medium (e.g., a floppy disk, hard disk, magnetic tape, any other magnetic medium), an optical computer readable medium (e.g., a compact disc read only memory (CD-ROM), a digital versatile disc (DVD), a Blu-Ray disc, or the like), a random access memory (RAM), a programmable read only memory (PROM), an erasable programmable read only memory (EPROM), a FLASH-EPROM, or any other non-transitory medium from which a computer can read. The term computer-readable storage medium is used herein to refer to any computer-readable medium except transmission media. However, it will be appreciated that where embodiments are described to use a computer-readable storage medium, other types of computer-readable mediums may be substituted for or used in addition to the computer-readable storage medium in alternative embodiments.

In the following, certain embodiments are explained with reference to a wireless device (or a station, or a terminal device) capable of wireless communication on a wireless access, via an access point or similar network node in a wireless local area network (LAN) or any other similar wireless communication system. The wireless device may comprise any suitable device capable of at least receiving wireless communication of data. For example, the wireless device can be handheld data processing device equipped with wireless receiver, data processing and user interface apparatus. Non-limiting examples include a mobile station (MS) such as a mobile phone or what is known as a “smart phone”, a portable computer such as a laptop or a tablet computer provided with a wireless interface card or other wireless interface facility, personal data assistant (PDA) provided with wireless communication capabilities, or any combinations of these or the like. Further examples include wearable wireless devices such as those integrated with watches or smart watches, eyewear, helmets, hats, clothing, ear pieces with wireless connectivity, jewelry and so on, universal serial bus (USB) sticks with wireless capabilities, modem data cards, machine type devices or any combinations of these or the like.

As mentioned hereinbefore, identifier configuration to STA is possible via at least one of the following: 1) network generated identifier; 2) STA generated identifier; or 3) commonly generated identifier.

When network generated identifier is used, an STA uses the identifier that the network configures to it. Here, because the network keeps the database of the identifiers, the network does not configure the same identifier to multiple STAs. Therefore, each STA will have a unique identifier and can use that unique identifier (which means there is no identifier collision). However, when STA generated identifier or commonly generated identifier is used, there is a possibility that multiple STAs choose or generate the same identifier. In this case, multiple STAs will not have a unique identifier and will use the same identifier (which means identifier collision). Identifier collision occurs because the network is not in control of configuring identifiers and each STA chooses or generates identifier itself without knowing of other STA's identifier.

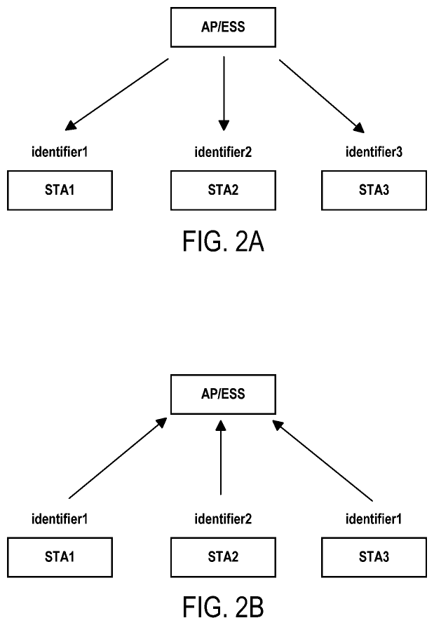

FIG. 2A illustrates an example scenario where no identifier collision occurs when network generated identifier is used. As shown in FIG. 2A, AP or extended service set (ESS) is in control of configuring identifiers (e.g., keeping a database of identifiers), and it therefore can configure a unique identifier to each STA (identifier1 to STA1, identifier2 to STA2, and identifier3 to STA3), making sure that there is no identifier collision. On the contrary, FIG. 2B illustrates an example scenario where identifier collision might occur when an STA generated identifier or commonly generated identifier is used. As shown in FIG. 2B, each STA chooses or generates its own identifier without knowing other STA's identifier, and two STAs chooses or generates the same identifier (STA1 and STA3 chooses the same identifier, i.e. identifier1), resulting in identifier collision.

The current 802.11 specification does not address this problem when this kind of identifier collision occurs. For example, when two STAs choose the same RMA to associate with an AP, the AP knows that there is an identifier collision, but STAs do not know if there is an identifier collision. In this scenario, two STAs are trying to connect to the AP with the same RMA. Here, what the AP can do is that it will accept one STA's association request (probably the one that comes first with the identifier), and rejects the other STA's association request with a possible reason code=UNSPECIFIED_REASON because there is no better reason code to manage this situation. Since the rejected STA does not know the real reason of the rejection (that is, it is rejected because of an identifier collision), it will probably try to send association request with the same RMA again (not knowing that its RMA is the problem) and get rejected again.

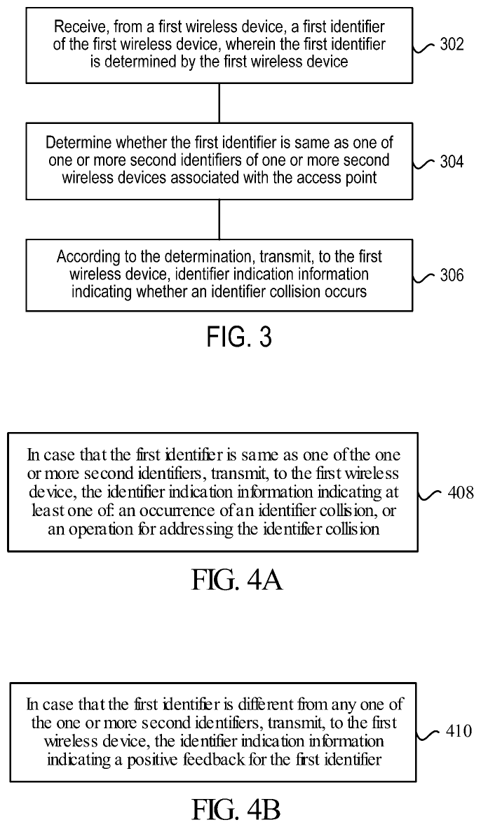

The present disclosure proposes an improved solution for identifier configuration. The solution may be applicable to a wireless LAN (or any other similar wireless communication system) including an access point (or a network node) and a wireless device (or a station or a terminal device). Hereinafter, the solution of the present disclosure will be described in detail with reference to FIGS. 3-17.

FIG. 3 is a flow chart depicting a method performed at an access point according to an embodiment of the present disclosure. At block 302, the access point receives, from a first wireless device, a first identifier of the first wireless device. The first identifier is determined by the first wireless device. The function of the first identifier is to identify the first wireless device. For example, the first identifier may be used when the first wireless device supports or uses random MAC address. As a first option, the first identifier may be an identity (ID) of the first wireless device. For example, suppose the ID has a length of x bits. Then, the first wireless device may choose, as the ID, one of the unused values which can be represented by the x bits. As a second option, the first identifier may be an identifiable random MAC address of the first wireless device that is independently determined by the first wireless device. For example, the random MAC address of the first wireless device may be independently determined as described in e.g. 23/129r3. As a third option, the first identifier may be an identifiable random MAC address of the first wireless device that is determined by the first wireless device and the access point through a common procedure. For example, the random MAC address of the first wireless device may be determined through a common procedure as described in e.g. 22/114r3. For any one of the above options, the first identifier of the first wireless device may be received by the access point in any suitable frame.

At block 304, the access point determines whether the first identifier is same as one of one or more second identifiers of one or more second wireless devices associated with the access point. For example, the one or more second wireless devices associated with the access point may be the wireless device(s) which are different from the first wireless device and are served by the access point. The function of the second identifier is to identify the second wireless device. For example, the second identifier may be used when the second wireless device supports or uses random MAC address. The one or more second identifiers may be determined by the one or more second wireless devices. Similar to the first identifier, the second identifier may be one of: an identity (ID) of the second wireless device; an identifiable random MAC address of the second wireless device that is independently determined by the second wireless device; and an identifiable random MAC address of the second wireless device that is determined by the second wireless device and the access point through a common procedure.

At block 306, according to the determination, the access point transmits, to the first wireless device, identifier indication information indicating whether an identifier collision occurs. For example, block 306 may be implemented as any one of block 408 of FIG. 4A and block 410 of FIG. 4B. At block 408, in case that the first identifier is same as one of the one or more second identifiers, the access point transmits, to the first wireless device, the identifier indication information indicating at least one of: an occurrence of an identifier collision, or an operation for addressing the identifier collision. For example, the identifier indication information indicating at least one of an occurrence of an identifier collision, or an operation for addressing the identifier collision may comprise, but not limited to, one or more of: a first indicator indicating an occurrence of an identifier collision; a second indicator instructing the first wireless device to use a new first identifier of the first wireless device; or a third indicator instructing the first wireless device to reuse a previous first identifier of the first wireless device. The previous first identifier has been previously used by the first wireless device without resulting in an identifier collision.

At block 410, in case that the first identifier is different from any one of the one or more second identifiers, the access point transmits, to the first wireless device, the identifier indication information indicating a positive feedback for the first identifier. For example, the identifier indication information indicating a positive feedback for the first identifier may comprise, but not limited to, one or more of: a fourth indicator indicating that the first identifier is acknowledged by the access point; or a fifth indicator indicating that the use of the first identifier by the first wireless device is successful.

For any one of block 408 and block 410, the identifier indication information may be transmitted as one of: a reason code; a status code; or an information element. For the example of reason code/status code, different reserved values for the corresponding reason code/status code may be used for representing different indication contents of the identifier indication information. For the example of information element, the information element may comprise: a first field indicating an element identifier of the information element; a second field indicating a length of the information element; a third field indicating an element identifier extension of the information element; and an indication content of the information element.

For any one of block 408 and block 410, the identifier indication information may be carried as one of following: a reason code in a de-authentication frame, a disassociation frame, and/or an action frame; a status code in an authentication frame, an association response frame, and/or an action frame; or an information element (IE) in an authentication frame, an association response frame, and/or an already existing action frame or a newly defined action frame. As an exemplary example, the newly defined action frame may comprise: a fourth field indicating a category code of the newly defined action frame; a fifth field indicating whether the newly defined action frame is a request or a response; the identifier indication information; and the first identifier (or the new first identifier, or the previous first identifier) of the first wireless device. Note that this example is merely for illustration purpose and some of the above constituents of the newly defined action frame may be optional.

With the method of FIG. 3, in case that an identifier collision occurs, there will be less frame exchanges between the first wireless device and the access point, because the first wireless device knows that it encounters identifier collision, and therefore, the first wireless device with identifier collision will avoid sending unnecessary frames, thereby increasing the network performance. In addition, the first wireless device and/or the access point can decide what to do next and take an action to avoid further identifier collision. In case that no identifier collision occurs, the first wireless device can definitely know this point and proceed normally.

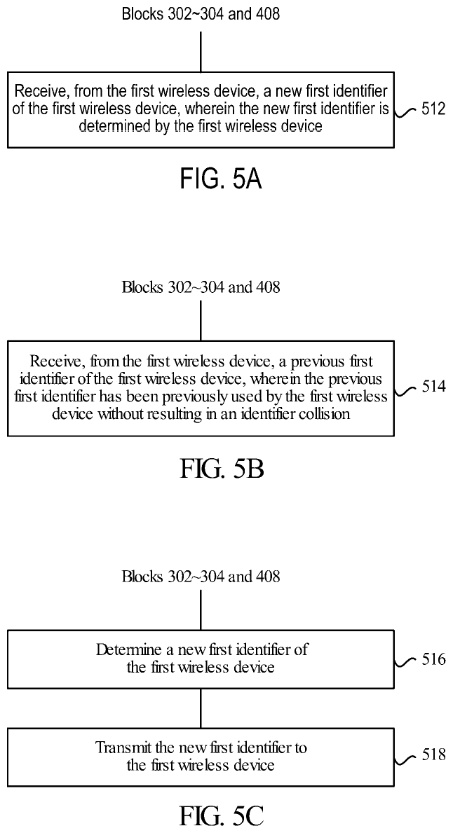

FIGS. 5A-5C are flow charts each depicting a method performed at an access point according to an embodiment of the present disclosure. The methods of FIG. 5A, FIG. 5B and FIG. 5C corresponds to the case where an identification collision occurs. Thus, each of these methods comprises blocks 302, 304 and 408. The difference between these methods lies in that the measures for solving the identifier collision are different. In the method of FIG. 5A, at block 512, the access point receives, from the first wireless device, a new first identifier of the first wireless device. The new first identifier is determined by the first wireless device. In the method of FIG. 5B, at block 514, the access point receives, from the first wireless device, a previous first identifier of the first wireless device. The previous first identifier has been previously used by the first wireless device without resulting in an identifier collision. In the method of FIG. 5C, at block 516, the access point determines a new first identifier of the first wireless device. As described above, there may be three options for the first wireless device to determine the first identifier. Similarly, the new first identifier may be determined by the access point in a similar way. At block 518, the access point transmits the new first identifier to the first wireless device. Blocks 516 and 518 may be performed when the access point determines that an identifier collision occurs, or may be performed in response to a request from the first wireless device. With any one of the methods of FIG. 5A, FIG. 5B and FIG. 5C, further identifier collision can be avoided thereby increasing the network performance.

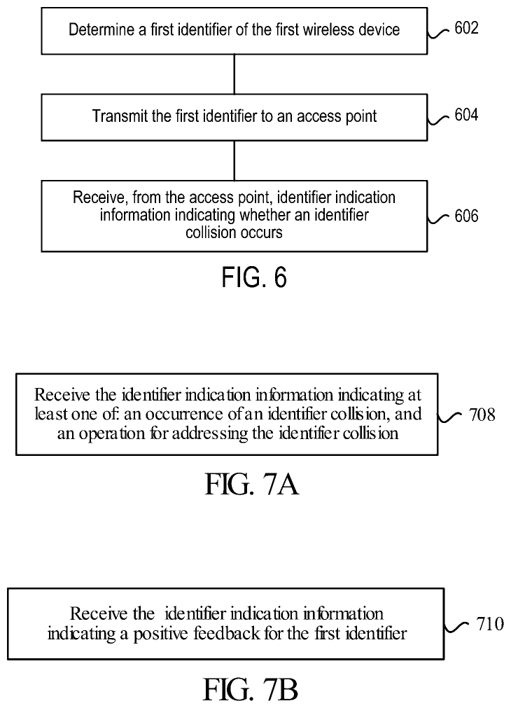

FIG. 6 is a flow chart depicting a method performed at a first wireless device according to an embodiment of the present disclosure. At block 602, the first wireless device determines a first identifier of the first wireless device. The function of the first identifier is to identify the first wireless device. For example, the first identifier may be used when the first wireless device supports or uses random MAC address. As a first option, the first identifier may be an identity (ID) of the first wireless device. For example, suppose the ID has a length of x bits. Then, the first wireless device may choose, as the ID, one of the unused values which can be represented by the x bits. As a second option, the first identifier may be an identifiable random MAC address of the first wireless device that is independently determined by the first wireless device. For example, the random MAC address of the first wireless device may be independently determined as described in e.g. 23/129r3. As a third option, the first identifier may be an identifiable random MAC address of the first wireless device that is determined by the first wireless device and the access point through a common procedure. For example, the random MAC address of the first wireless device may be determined through a common procedure as described in e.g. 22/114r3.

At block 604, the first wireless device transmits the first identifier to an access point. For example, the first identifier of the first wireless device may be transmitted to the access point in any suitable frame.

At block 606, the first wireless device receives, from the access point, identifier indication information indicating whether an identifier collision occurs. For example, block 606 may be implemented as any one of block 708 of FIG. 7A and block 710 of FIG. 7B. At block 708, the first wireless device receives the identifier indication information indicating at least one of: an occurrence of an identifier collision, or an operation for addressing the identifier collision. For example, the identifier indication information indicating at least one of an occurrence of an identifier collision, or an operation for addressing the identifier collision may comprise, but not limited to, one or more of: a first indicator indicating an occurrence of an identifier collision; a second indicator instructing the first wireless device to use a new first identifier of the first wireless device; or a third indicator instructing the first wireless device to reuse a previous first identifier of the first wireless device. The previous first identifier has been previously used by the first wireless device without resulting in an identifier collision.

At block 710, the first wireless device receives the identifier indication information indicating a positive feedback for the first identifier. For example, the identifier indication information indicating a positive feedback for the first identifier may comprise, but not limited to, one or more of: a fourth indicator indicating that the first identifier is acknowledged by the access point; or a fifth indicator indicating that the use of the first identifier by the first wireless device is successful.

For any one of block 708 and block 710, the identifier indication information may be received as one of: a reason code; a status code; or an information element. For the example of reason code/status code, different reserved values for the corresponding reason code/status code may be used for representing different indication contents of the identifier indication information. For the example of information element, the information element may comprise: a first field indicating an element identifier of the information element; a second field indicating a length of the information element; a third field indicating an element identifier extension of the information element; and an indication content of the information element.

For any one of block 708 and block 710, the identifier indication information may be received as one of following: a reason code in a de-authentication frame, a disassociation frame, and/or an action frame; a status code in an authentication frame, an association response frame, and/or an action frame; or an information element (IE) in an authentication frame, an association response frame, and/or an already existing action frame or a newly defined action frame. As an exemplary example, the newly defined action frame may comprise: a fourth field indicating a category code of the newly defined action frame; a fifth field indicating whether the newly defined action frame is a request or a response; the identifier indication information; and the first identifier (or the new first identifier, or the previous first identifier) of the first wireless device. Note that this example is merely for illustration purpose and some of the above constituents of the newly defined action frame may be optional.

With the method of FIG. 6, in case that an identifier collision occurs, there will be less frame exchanges between the first wireless device and the access point, because the first wireless device knows that it encounters identifier collision, and therefore, the first wireless device with identifier collision will avoid sending unnecessary frames, thereby increasing the network performance. In addition, the first wireless device and/or the access point can decide what to do next and take an action to avoid further identifier collision. In case that no identifier collision occurs, the first wireless device can definitely know this point and proceed normally.

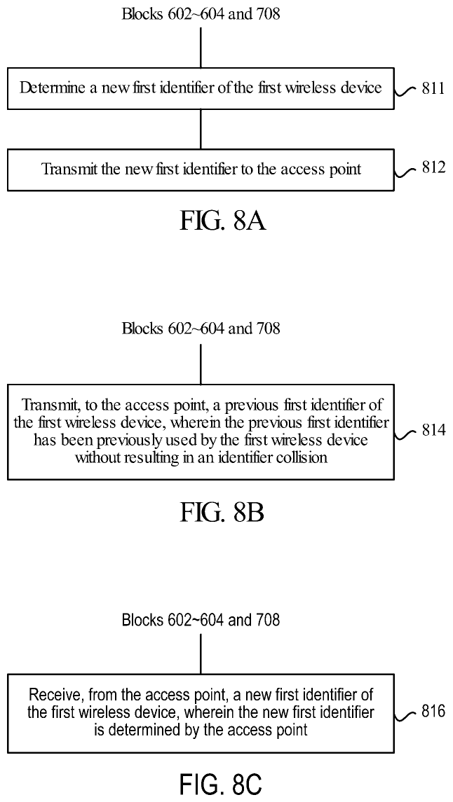

FIGS. 8A-8C are flow charts each depicting a method performed at a first wireless device according to an embodiment of the present disclosure. The methods of FIG. 8A, FIG. 8B and FIG. 8C corresponds to the case where an identification collision occurs. Thus, each of these methods comprises blocks 602, 604 and 708. The difference between these methods lies in that the measures for solving the identifier collision are different. In the method of FIG. 8A, at block 811, the first wireless device determines a new first identifier of the first wireless device. At block 812, the first wireless device transmits the new first identifier to the access point. In the method of FIG. 8B, at block 814, the first wireless device transmits, to the access point, a previous first identifier of the first wireless device. The previous first identifier has been previously used by the first wireless device without resulting in an identifier collision. In the method of FIG. 8C, at block 816, the first wireless device receives, from the access point, a new first identifier of the first wireless device. The new first identifier is determined by the access point. The new first identifier may be received without any further request from the first wireless device to the access point, or may be received in response to a request from the first wireless device to the access point. With any one of the methods of FIG. 8A, FIG. 8B and FIG. 8C, further identifier collision can be avoided thereby increasing the network performance.

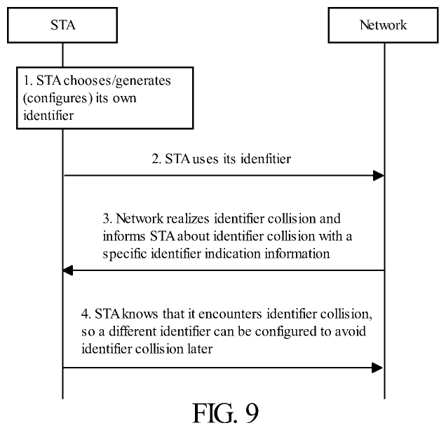

FIG. 9 is a flow chart depicting an exemplary process according to an embodiment of the present disclosure. The process provides a method to avoid identifier collision among different STAs. Specifically, when a STA chooses (configures identifier to itself) or generates (through a common procedure) its identifier, it might be possible that another STA chooses or generates the same identifier, causing identifier collision. In this case, the STA should know that the problem is the identifier collision.

In this context, this method proposes to (pre-) define a set of identifier indication information that addresses the identifier collision. That is, when more than one STA uses the same identifier, the network will check the received configured identifier, and inform corresponding STAs about the identifier collision so that the STAs or network would configure another identifier for the STAs to avoid the identifier collision issue later.

Note that a network in this context may mean a single AP or AP multi-link device (MLD) in basic service set (BSS), or multiple APs and/or AP-MLDs in extended service set (ESS). Also note that an STA might be configured with multiple identifiers (e.g., multiple IDs or multiple RMAs) and use at least one of them. The present disclosure does not differentiate between single identifier or multiple identifiers. That is, the present disclosure covers both the single identifier case and multiple identifiers case. For simplicity, both cases (single and multiple identifier(s)) are referred to as identifiers in the present disclosure. Also note that an AP in the present disclosure refers to a single AP in BSS or in ESS. For simplicity, the present disclosure may also use the term “network” for both cases.

As shown in FIG. 9, at step 1, an STA chooses (configures identifier to itself) or generates (through a common procedure) its own identifier. At step 2, the STA uses its identifier from step 1 (sends its identifier to network) without knowing about other STA's identifiers. The STA thinks its identifier is safe and valid. At step 3, a network receives STA's identifier and realizes identifier collision (another STA is using the same identifier). The network informs the STA about identifier collision by sending specific identifier indication information.

At step 4, the STA understands about identifier collision and can decide to take a corresponding action, such as, configure a different identifier in the subsequent frame exchange procedure to avoid identifier collision later. Note that avoiding the identifier collision can be achieved by the STA or the network via one of the following actions: 1) the STA configures a new identifier and tries to connect to the network with it; 2) the STA uses a previously known identifier which did not result in an identifier collision; 3) the STA requests the network to configure an identifier for itself; 4) the network configures a new identifier to the STA so that STA can use it without identifier collision.

For example, the specific identifier indication information indicating the occurrence of the identifier collision sent at step 3 can be carried as one of: a reason code in a de-authentication frame, a disassociation frame, and/or an action frame; a status code in an authentication frame, an association response frame, and/or an action frame; or an information element (IE) in an authentication frame, an association response frame, and/or an already existing action frame or a newly defined action frame. The identifier indication information can be carried encrypted or unencrypted. The encryption may be enabled or disabled by a negotiation process between the STA and the network.

In the above process, by utilizing the identifier indication information about identifier collision, an STA and/or an AP can decide what to do next and take an action, as illustrated above (see actions to avoid identifier collision). There will be less frame exchanges between the STA and network because the STA knows that it encounters identifier collision, and therefore, the STA with identifier collision will avoid sending unnecessary frames, thereby increasing the network performance by allowing the same STA or other STAs to be served. In addition, networks that utilize STA generated identifier or commonly generated identifier can be managed better, because those networks are sometimes more preferred in practical scenarios, considering that STAs want to define and use their own identifiers instead of being forced to use the identifier that network configures.

For ease of understanding, the following Table 1 gives exemplary examples for the identifier indication information.

TABLE 1
Examples of identifier indication information

| No. | Name | Definition |
|---|---|---|
| 1 | SUCCESS | Successful. |
| 2 | FAILURE | Unspecified failure. |
| 3 | ID_ACK | ID is acknowledged (which means that the ID |
| | | is accepted, known or recognized by AP) |
| 4 | MAC_ACK | MAC is acknowledged (which means that the |
| | | MAC is accepted, known or recognized by AP) |
| 5 | PAREMETER_ACK | PARAMETER is acknowledged (which means |
| | | that the parameter is accepted, known or |
| | | recognized by AP) |
| 6 | ID_NACK | ID is not acknowledged (which means AP does |
| | | not accept, know or recognize the ID) |
| 7 | MAC_NACK | MAC is not acknowledged (which means AP |
| | | does not accept, know or recognize the MAC) |
| 8 | PARAMETER_NACK | Parameter is not acknowledged (which means |
| | | AP does not accepted, not known or recognize |
| | | the parameter) |
| 9 | ID_COLLISION | ID is collided (used by another STA) |
| 10 | MAC_COLLISION | MAC is collided (used by another STA) |
| 11 | PARAMETER_COLLISION | Parameter is collided (used by another STA) |
| 12 | ID_AGAIN | STA needs to resend ID (i.e., an ID known or |
| | | accepted by AP) |
| 13 | MAC_AGAIN | STA needs to resend MAC (i.e., an MAC |
| | | known or accepted by AP) |
| 14 | PARAMETER_AGAIN | STA needs to resend PARAMETER (i.e., one or |
| | | more parameters known or accepted by AP) |
| 15 | ID_OTHER | STA needs to use other ID |
| 16 | MAC_OTHER | STA needs to use other MAC |
| 17 | PARAMETER_OTHER | STA needs to use other parameter |
| reserved | Other | |

The “MAC” mentioned in Table 1 may correspond to the RMA mentioned in e.g. 23/129r3. The “PARAMETER” mentioned in Table 1 may correspond to the parameters for generating a commonly generated RMA mentioned in e.g. 22/114r3. The first identifier indication information mentioned at block 408 or 708 may include one or more of item 9~item 17 in Table 1. The second identifier indication information mentioned at block 410 or 710 may include one or more of item 1, item 3, item 4, and item 5. The identifier indication information can be at least one of the above items in Table 1. For example, if a network wants to require an STA to configure a new identifier and try to connect to the network with it, item 15 or a combination of (item 9, item 15) in Table 1 may be used as the identifier indication information. If the network wants to require STA to use a previously known identifier which is not collided, item 12 or a combination of (item 9, item 12) may be used as the identifier indication information.

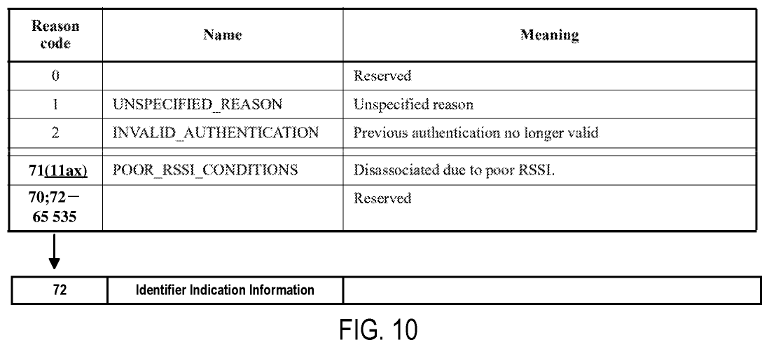

FIG. 10 illustrates an exemplary example of identifier indication information as reason code. According to the table shown in FIG. 10 which is defined by 802.11 REVme_D2.1 SPEC, this example proposes a new reason code to indicate identifier indication information (e.g., reason code=72). For instance, reason code 72.9 may indicate “ID_COLLISION”, reason code 72.10 may indicate “MAC_COLLISION”, and reason code 72.11 may indicate “PARAMETER_COLLISION”. The digits “9”, “10” and “11” correspond to item Nos. “9”, “10” and “11” in Table 1 respectively. Such reason code belonging to the first identifier indication information can be used with de-authentication and/or disassociation frames.

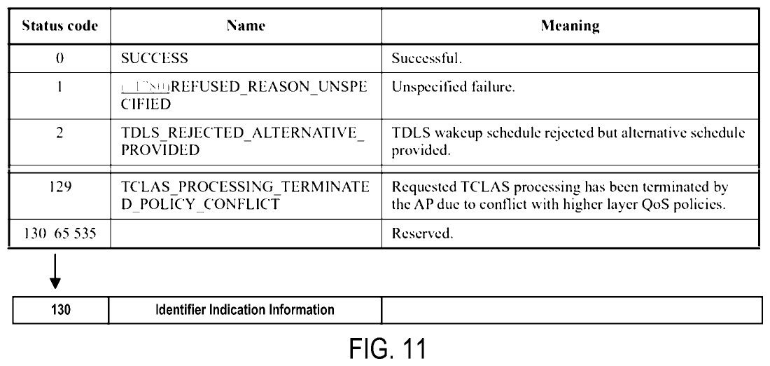

FIG. 11 illustrates an exemplary example of identifier indication information as status code. According to the table shown in FIG. 11 which is defined by 802.11 REVme_D2.1 SPEC, this example proposes a new status code to indicate identifier indication information (e.g., status code=130). For instance, status code 130.9 may indicate “ID_COLLISION”, status code 130.10 may indicate “MAC_COLLISION”, and status code 130.11 may indicate “PARAMETER_COLLISION”. The digits “9”, “10” and “11” correspond to item Nos. “9”, “10” and “11” in Table 1 respectively. Such status code belonging to the first identifier indication information can be used with some action frames.

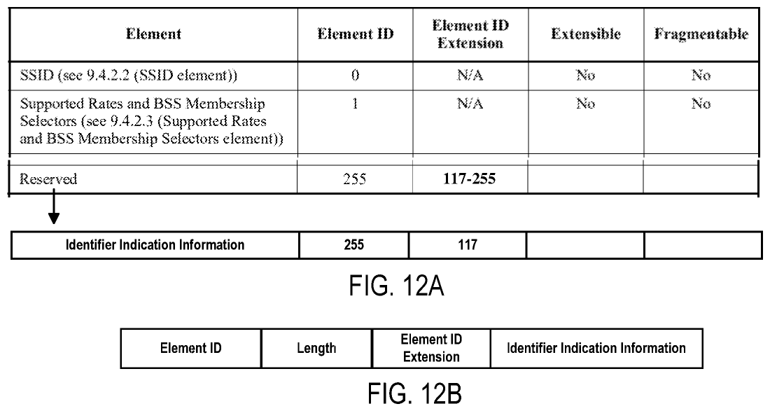

FIGS. 12A-12B illustrate an exemplary example of identifier indication information as information element (IE). According to the table shown in FIG. 12A which is defined by 802.11 REVme_D2.1 SPEC, this example proposes an IE defined as Identifier Indication Information IE. It has Element ID=255 and Element ID Extension=117, as shown in FIG. 12A. FIG. 12B illustrates the structure of the Identifier Indication Information IE. As shown, the Identifier Indication Information IE has Element ID field (=255), Length field (=x bits), element ID extension field (=117), and Identifier Indication Information which may be y bits. Optionally, in addition to the identifier indication information defined in Table 1, Identifier Indication Information IE can also include other fields such as the identifier (for instance, MAC address, ID), public/private parameters, public/private key.

The Identifier Indication Information IE can be carried in one of the existing action frames. One of such examples is using generic advertisement service (GAS) initial request and GAS initial response, where STA uses its configured identifier in GAS initial request, and AP responds Identifier Indication Information IE in GAS initial response.

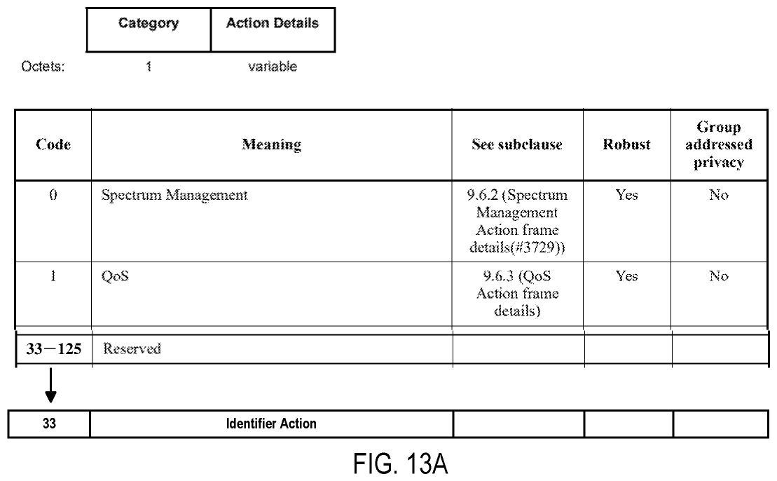

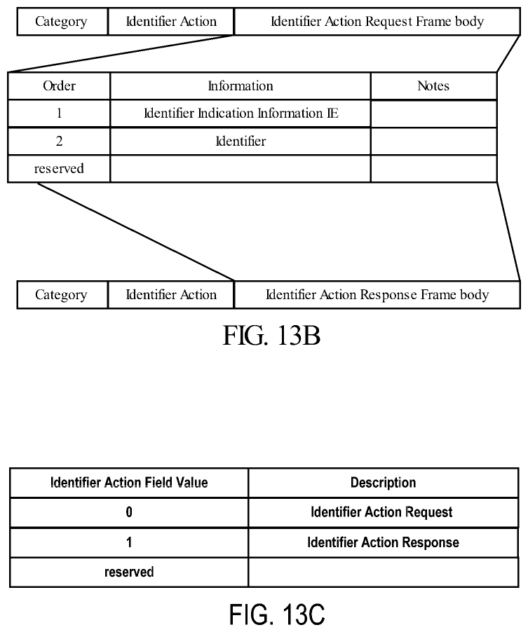

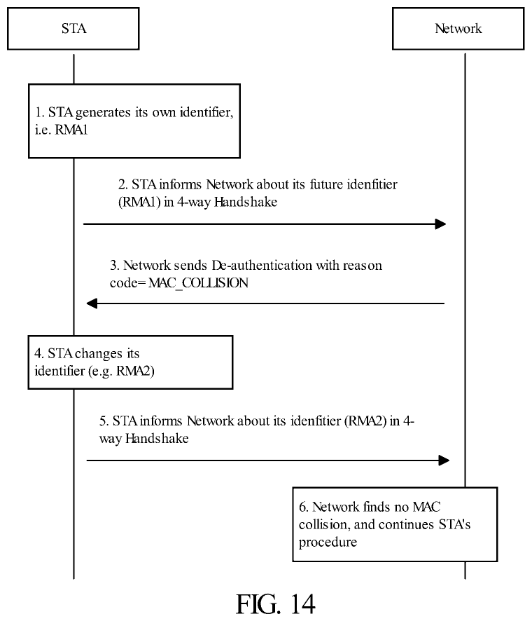

Alternatively, the Identifier Indication Information IE can also be carried in a newly defined action frame. FIGS. 13A-13C illustrate an exemplary example of such newly defined action frame. As shown in FIG. 13A, the newly defined action frame is defined as Identifier Action Frame with Category code=33. FIG. 13B illustrates the structure of the Identifier Action Frame. As shown in FIG. 13B, the Identifier Action Frame has Category field (=33), Identifier Action field, and Identifier Action Request/Response Frame body. As shown in FIG. 13C, the Identifier Action field can take the value of 0 or 1 so that two Identifier Action Frame formats are defined to manage identifier collision, namely, Identifier Action Request (sent from STA to AP), and Identifier Action Response (sent from AP to STA).

Referring back to FIG. 13B, each of Identifier Action Request Frame body and Identifier Action Response Frame body includes at least Identifier Indication Information IE (order=1) and identifier (order=2). The usage of these fields depends on the implementation. For example, if the network only wants to inform STA about identifier collision, the network only includes Identifier Indication Information IE (order=1) in Identifier Action Response Frame. If the network wants to configure STA's identifier (in addition to informing STA about identifier collision), the network includes Identifier Indication Information IE (order=1) and identifier (order=2) in Identifier Action Response Frame.

Optionally, in addition to Identifier Indication Information IE (order=1) and identifier (order=2, where identifier implies MAC address or ID), each of Identifier Indication Information Action Request and Response Frame Body can also include other fields such public/private parameters, public/private key (order=reserved).

FIG. 14 is a flow chart depicting Example Scenario 1 where an STA generates its own identifier (e.g., Random MAC). At step 1, an STA generates its own identifier (RMA1) without knowing other STA's generated identifiers (RMAs). At step 2, the STA informs network about its future identifier (e.g., denoted as RMA1), e.g., in 4-way Handshake. This implies that the STA will change its identifier to RMA1 in the future. At step 3, a network realizes that another STA generated the same RMA (i.e., RMA1), and therefore, the network sends specific identifier indication information as a reason code, e.g., =MAC_COLLISION as defined in table 1, in de-authentication frame to the STA. This implies that the STA cannot use its own generated RMA because of MAC collision. At step 4, the STA receives the de-authentication frame (with the specific identifier indication information, i.e. reason code=MAC_COLLISION) and realizes that its generated RMA is collided. Therefore, the STA generates another identifier (RMA2). At step 5, the STA informs the network about its new future identifier (e.g., denoted as RMA2) in 4-way Handshake again. This implies that the STA will change its identifier to RMA2 in the future. At step 6, after receiving RMA2 from the STA, the network finds no MAC collision. This implies that the STA will be able to use RMA2 in the future. Therefore, the network allows the STA to continue its procedure (e.g., connection establishment).

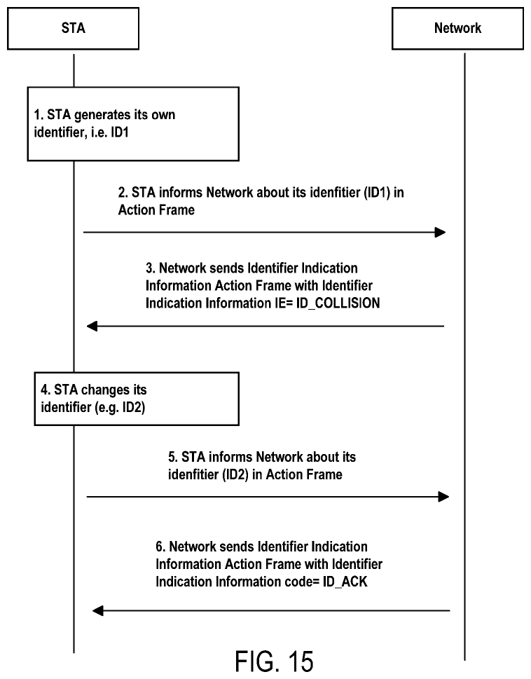

FIG. 15 is a flow chart depicting Example Scenario 2 where STA generates its own identifier (e.g., ID). At step 1, a STA generates its own identifier (e.g., denoted as ID1) without knowing other STA's generated identifiers (IDs). At step 2, the STA informs network about its identifier (ID1) in an Action Frame. At step 3, network realizes that another STA generated the same ID (i.e., ID1), and therefore, it sends Identifier Indication Information Action Frame with Identifier Indication Information IE, e.g., =ID_COLLISION as defined in table 1, to STA. This implies that the STA cannot use its own generated ID because of ID collision. At step 4, STA receives the Identifier Indication Information Action Frame and realizes that its generated ID is collided. Therefore, STA generates another identifier (ID2). At step 5, STA informs network about its new identifier (ID2) in Action Frame again. At step 6, after receiving ID2 from the STA, the network finds no ID collision. This implies that the STA will be able to use ID2. Therefore, the network sends Identifier Indication Information Action Frame with Identifier Indication Information IE=ID_ACK to the STA.

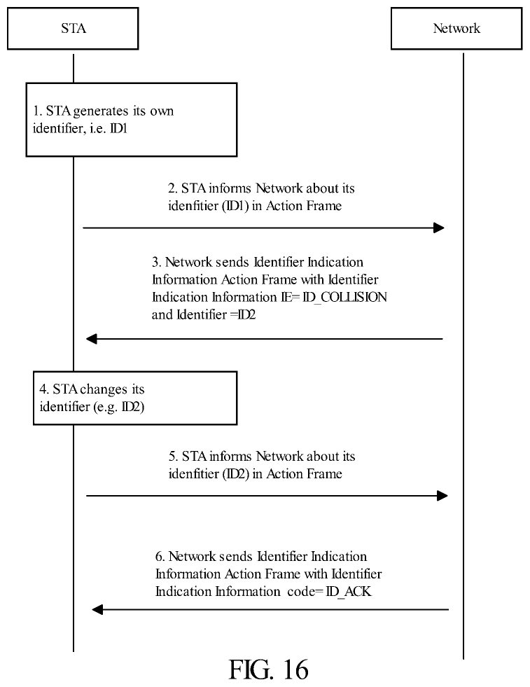

FIG. 16 is a flow chart depicting Example Scenario 3 where STA generates its own identifier (e.g., ID). At step 1, an STA generates its own identifier (denoted as ID1) without knowing other STA's generated identifiers (IDs). At step 2, the STA informs network about its identifier (ID1) in an Action Frame. At step 3, network realizes that another STA generated the same ID (i.e., ID1), and therefore, it sends Identifier Indication Information Action Frame with Identifier Indication Information IE, e.g., =ID_COLLISION as defined in table 1, to the STA. This implies that the STA cannot use its own generated ID because of ID collision. The network also sends the identifier (i.e., ID2) to the STA so that the STA will not experience ID collision later by using ID2. Note that the same action frame is used to indicate Identifier Indication Information and identifier configuration for the STA. At step 4, the STA receives the Identifier Indication Information Action Frame and realizes that its generated ID is collided. The STA also receives the new identifier that the network asks the STA to use. Therefore, the STA uses that identifier (ID2). At step 5, the STA acknowledges its new identifier (ID2) with the network in Action Frame. At step 6, the network sends Identifier Indication Information Action Frame with Identifier Indication Information IE=ID_ACK to the STA to respond the STA's acknowledgment about the STA's new identifier (ID2).

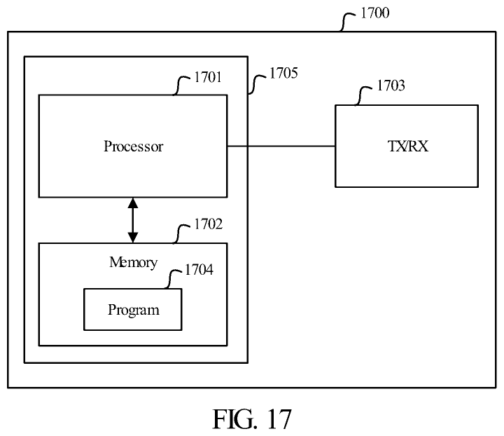

Now reference is made to FIG. 17 illustrating a simplified block diagram of an apparatus 1700 that may be embodied in/as the access point, or the first wireless device. The apparatus 1700 may comprise at least one processor 1701, such as a data processor (DP) and at least one memory 1702 coupled to the at least one processor 1701. The apparatus 1700 may further comprise one or more transmitters TX, one or more receivers RX 1703, or one or more transceivers coupled to the one or more processors 1701 to communicate wirelessly and/or through wireline.

Although not shown, the apparatus 1700 may have at least one communication interface, for example, the communicate interface can be at least one antenna, or transceiver as shown in the FIG. 17. The communication interface may represent any interface that is necessary for communication with other network entities.

The processors 1701 may be of any type suitable to the local technical environment, and may include one or more of the following: general purpose computers, special purpose computers, microprocessors, digital signal processors (DSPs) and processors based on multicore processor architecture, as non-limiting examples.

The memory 1702 may be of any type suitable to the local technical environment and may be implemented using any suitable data storage technology, such as semiconductor-based memory devices, magnetic memory devices and systems, optical memory devices and systems, fixed memory and removable memory, as non-limiting examples.

The memory 1702 stores a program 1704. The program 1704 may include instructions that, when executed on the associated processor 1701, enable the apparatus 1700 to operate in accordance with the embodiments of the present disclosure. A combination of the at least one processor 1701 and the at least one memory 1702 may form processing circuitry or means 1705 adapted to implement various embodiments of the present disclosure.

Various embodiments of the present disclosure may be implemented by computer program executable by one or more of the processors 1701, software, firmware, hardware or in a combination thereof.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosures may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosures may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium, for example, non-transitory computer readable medium, such as a hard disk, optical disk, removable storage media, solid state memory, RAM, etc. As will be appreciated by one of skills in the art, the function of the program modules may be combined or distributed as desired in various embodiments. In addition, the function may be embodied in whole or in part in firmware or hardware equivalents such as integrated circuits, field programmable gate arrays (FPGA), and the like.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, the term “and/or” includes any and all combinations of one or more of the listed terms.

As used herein, the phrase “at least one of A and B” or “at least one of A or B” should be understood to mean “only A, only B, or both A and B.” The phrase “A and/or B” should be understood to mean “only A, only B, or both A and B”.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

1-12. (canceled)

13. An apparatus at a first wireless device, the apparatus comprising:
at least one processor; and
at least one memory storing instructions that, when executed by the at least one processor, cause the apparatus at least to:
determine a first identifier of the first wireless device;
transmit the first identifier to an access point; and
receive, from the access point, identifier indication information indicating whether an identifier collision occurs.

14. The apparatus according to claim 13, wherein when the instructions are executed by the at least one processor, the instructions cause the apparatus at least to receive the identifier indication information by:
receiving the identifier indication information indicating at least one of: an occurrence of an identifier collision, or an operation for addressing the identifier collision.

15. The apparatus according to claim 14, wherein the identifier indication information indicating at least one of an occurrence of an identifier collision, or an operation for addressing the identifier collision comprises one or more of:
a first indicator indicating an occurrence of an identifier collision;
a second indicator instructing the first wireless device to use a new first identifier of the first wireless device; or
a third indicator instructing the first wireless device to reuse a previous first identifier of the first wireless device, wherein the previous first identifier has been previously used by the first wireless device without resulting in an identifier collision.

16. The apparatus according to claim 14, wherein
when the instructions are executed by the at least one processor, the instructions further cause the apparatus at least to perform one of:
determining a new first identifier of the first wireless device and transmitting the new first identifier to the access point;
transmitting, to the access point, a previous first identifier of the first wireless device, wherein the previous first identifier has been previously used by the first wireless device without resulting in an identifier collision; and
receiving, from the access point, a new first identifier of the first wireless device, wherein the new first identifier is determined by the access point.

17. The apparatus according to claim 16, wherein the new first identifier is received in response to a request from the first wireless device to the access point.

18. The apparatus according to claim 13, wherein when the instructions are executed by the at least one processor, the instructions cause the apparatus at least to receive the identifier indication information by:
receiving the identifier indication information indicating a positive feedback for the first identifier.

19. The apparatus according to claim 18, wherein the identifier indication information indicating a positive feedback for the first identifier comprises one or more of:
a fourth indicator indicating that the first identifier is acknowledged by the access point; or
a fifth indicator indicating that the use of the first identifier by the first wireless device is successful.

20. The apparatus according to claim 13, wherein the identifier indication information is received as one of:
a reason code;
a status code; and
an information element.

21. The apparatus according to claim 20, wherein the information element comprises:
a first field indicating an element identifier of the information element;
a second field indicating a length of the information element;
a third field indicating an element identifier extension of the information element; and
an indication content of the information element.

22. The apparatus according to claim 13, wherein the identifier indication information is received as one of:
a reason code in a de-authentication frame, a disassociation frame, and/or an action frame;
a status code in an authentication frame, an association response frame, and/or an action frame; or
an information element in an authentication frame, an association response frame, and/or an already existing action frame or a newly defined action frame.

23. The apparatus according to claim 22, wherein the newly defined action frame comprises one or more of:
a fourth field indicating a category code of the newly defined action frame;
a fifth field indicating whether the newly defined action frame is a request or a response;
the identifier indication information; or
the first identifier of the first wireless device.

24. The apparatus according to claim 13, wherein the first identifier of the first wireless device is one of:
an identity of the first wireless device;
a random medium access control, MAC, address of the first wireless device that is independently determined by the first wireless device; or
a random MAC address of the first wireless device that is determined by the first wireless device and the access point through a common procedure.

25-36. (canceled)

37. A method performed at a first wireless device, the method comprising:
determining a first identifier of the first wireless device;
transmitting the first identifier to an access point; and
receiving, from the access point, identifier indication information indicating whether an identifier collision occurs.

38. The method according to claim 37, wherein receiving the identifier indication information comprises:
receiving the identifier indication information indicating at least one of: an occurrence of an identifier collision, or an operation for addressing the identifier collision.

39. The method according to claim 38, wherein the identifier indication information indicating at least one of an occurrence of an identifier collision, or an operation for addressing the identifier collision comprises one or more of:
a first indicator indicating an occurrence of an identifier collision;
a second indicator instructing the first wireless device to use a new first identifier of the first wireless device; or
a third indicator instructing the first wireless device to reuse a previous first identifier of the first wireless device, wherein the previous first identifier has been previously used by the first wireless device without resulting in an identifier collision.

40. The method according to claim 38, further comprising one of:
determining a new first identifier of the first wireless device and transmitting the new first identifier to the access point;
transmitting, to the access point, a previous first identifier of the first wireless device, wherein the previous first identifier has been previously used by the first wireless device without resulting in an identifier collision; and
receiving, from the access point, a new first identifier of the first wireless device, wherein the new first identifier is determined by the access point.

41. (canceled)

42. The method according to claim 37, wherein receiving the identifier indication information comprises:
receiving the identifier indication information indicating a positive feedback for the first identifier.

43. The method according to claim 42, wherein the identifier indication information indicating a positive feedback for the first identifier comprises one or more of:
a fourth indicator indicating that the first identifier is acknowledged by the access point; or
a fifth indicator indicating that the use of the first identifier by the first wireless device is successful.

44. The method according to claim 37, wherein the identifier indication information is received as one of:
a reason code;
a status code; and
an information element.

45. (canceled)

46. The method according to claim 37, wherein the identifier indication information is received as one of:
a reason code in a de-authentication frame, a disassociation frame, and/or an action frame;
a status code in an authentication frame, an association response frame, and/or an action frame; or
an information element in an authentication frame, an association response frame, and/or an already existing action frame or a newly defined action frame.

47-50. (canceled)
